(19) United States
(12) Patent Application Publication
(10) Pub. No.: US 2006/0269151 A1
(43) Pub. Date: Nov. 30, 2006

(54) Encoding method and encoding apparatus

(76) Inventor: Hiroyuki Sakuyama, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/441,565

(22) Filed: May 25, 2006

(30) Foreign Application Priority Data
May 25, 2005 (JP) 2005-152340

(51) Int. Cl. G06K 9/36

(52) U.S. Cl. 382/232

(57) ABSTRACT

An encoding method includes acquiring background data, and at least one pair of foreground data and mask data, that are obtained by decomposing original image data, and encoding the background data, the foreground data and the mask data acquired by the data acquiring step, including performing a JPEG2000 encoding using tile division or precinct division with respect to the mask data.

### PRIORITY

The present application claims priority to and incorporates by reference the entire contents of Japanese priority document 2005-152340, filed in Japan on May 25, 2005.

### BACKGROUND OF THE INVENTION

1. Field of the Invention

The present invention generally relates to encoding methods and apparatuses for encoding page images of mixed documents of characters, lines, photographs and the like, and more particularly to an encoding method which does not encode original image data as it is but encodes background data and at least one pair of foreground image and mask data that are obtained by decomposing the original image data, and to an encoding apparatus which employs such an encoding method. The present invention also relates to a computer program for causing a computer to perform an encoding process by such an encoding method, and to a computer-readable storage medium that stores such a computer program.

2. Description of the Related Art

Generally, the document is made up of a mixture of characters, lines and images. Recently, in order to efficiently encode such a mixed document, a technique has been proposed to decompose the document page (original image data) into the background data, and one or a plurality of pairs of the foreground data and the mask data, and to independently encode these data.

For example, according to the Mixed Raster Content (MRC), the original image data is decomposed into the foreground data that is the color information of the characters, the mask data that is the character region information, and the background data that is the image information, and the background data, the foreground data and the mask data are independently encoded. When reproducing the original image data, the foreground data or the background data is selected according to the mask data for each pixel. It is also possible to decompose the original image data into the background data and two or more pairs of the foreground data and the mask data, and to encode each of these data.

With regard to the MRC, a Japanese Patent No. 3275807 proposes an image processing apparatus that encodes and expands the image. A multi-level pattern image (background) representing the pattern portion of the original image, a multi-level character color image (foreground) representing the color information of the character and line portion of the original image, and binary selection data (mask) representing the shape of the characters and lines of the original image are respectively encoded by the JPEG, Lempel-Ziv and MMR to obtain codes. Each of the codes is expanded, and the expanded pattern image data or character color image data is selected according to the selection data for each pixel, so as to reproduce the original image. As described in paragraphs 0003 to 0005 of the Japanese Patent No. 3275807, the main object is to prevent the deterioration of the characters and lines when the compression rate is high.

Since the recent proposal of the new encoding technique JPEG2000, the JPM (JPEG2000 Multi Layer) has been proposed to select the JPEG2000 for the compression technique that is to be used for the foreground data, the mask data and the background data of the MRC model. In addition, the JPIP (JPEG2000 Interactive Protocol) has been proposed “to encode, transmit and receive only the codes of the desired region within the image that has been encoded by the JPEG2000” in a network environment. A brief description will be given with respect to such proposed techniques.

First, a description will be given of the JPM. According to the JPM, the original image data is decomposed into one background data (Base Page), and one or a plurality of layout objects that are called “pairs of foreground data and mask data”. The background data of the JPM is treated as an initial page in which the layout object is plotted. The background data, the foreground data and the mask data are independently encoded, and the JPEG2000 can be selected as the encoding technique.

For example, when reproducing the original image data that has been decomposed into the background data, the pair of foreground data 1 and mask data 1, and the pair of foreground data 2 and mask data 2, the background data 2 is formed from the foreground data 1 and the background data according to the mask data 1. Then, the background data 3 is formed from the foreground data 2 and the background data 2 according to the mask data 2. In this particular example, the background data 3 that is formed becomes the reproduced image data. The original image can be reproduced by repeating a similar image combining procedure, even if the pairs of foreground data and mask data increase.

As a method of combining the background data and the foreground data, it is possible to employ a method (i) that selects the foreground data or the background data for each pixel or, a method (ii) that obtains a weighted average of the foreground data and the background data for each pixel.

According to the method (i), the mask data may be binary data, and the foreground data may be selected at the pixel position where the value of the mask data is “1”, while the background data may be selected at the pixel position where the value of the mask data is “0”. According to the method (ii), the mask data may be a positive 8-bit value, and the weighted average of the foreground data and the background data may be obtained for each pixel. In other words, the pixel value of the combined image may be calculated from (combined image)={(mask value)/255)}×(foreground)+[{255−(mask value)}/255]×(background). One of the methods (i) and (ii) to be employed can be specified for each pair of the foreground data and the mask data, and the method is specified in a header for each pair. The header will be described later in the specification.

Next, a description will be given of the JPEG2000. The JPEG2000 is the image encoding technique that is to succeed the JPEG, and has become an International Standard in 2001. The encoding process of the JPEG2000 is generally performed in a sequence shown in FIG. 2. In FIG. 2, the JPEG2000 encoding process generally includes the following steps ST1 through ST6.
ST1: D.C. level shift and color transform for each tile.
ST2: Wavelet transform for each tile.
ST3: Quantization for each sub-band.
ST4: Bit-plane encoding for each code block.
ST5: Discard unnecessary codes, and collect necessary codes to generate packets.
ST6: Code formation by arranging packets.

First, the image is divided into rectangular tiles, where the number of divisions is greater than or equal to one. Each tile is transformed into a component of luminance, color difference or the like. The components after the transform, called tile components, are divided into four sub-bands called LL, HL, LH and HH by wavelet transform. When the wavelet transform (or decomposition) is recursively repeated with respect to the sub-band LL, one sub-band LL and a plurality of sub-bands HL, LH and HH are finally generated.

Next, each sub-band is divided into rectangular regions called precincts, as shown in FIG. 3. The precincts corresponding to each of the sub-bands HL, LH and HH are treated as a group (three groups in this case). However, each of the precincts corresponding to the sub-band LL is treated independently as a precinct. The precinct generally represents the position within the image. The precinct may have the same size as the sub-band. The precinct is further divided into rectangular regions called code blocks, as shown in FIG. 3. Accordingly, the ideal size relationship of the region is (image)≧(tile)>(sub-band)≧(precinct)≧(code block).

FIG. 4 shows an example of the sub-band division. In FIG. 4, each prefix number added to the sub-bands LL, HL, LH and HH indicates the number of wavelet transforms performed to obtain the corresponding coefficient, that is, the decomposition level. FIG. 4 also shows the relationship of the decomposition level and the resolution level.

After making the division described above, an entropy encoding (or bit-plane encoding) is performed with respect to each sub-band coefficient for each code block in the bit-plane sequence. In a case where an irreversible wavelet transform called the 9×7 transform is employed, the entropy encoding is performed with respect to each sub-band coefficient after linear quantization for each sub-band.

A packet is obtained by adding a header to a collection of portions of bit-plane codes from all of the code blocks included in the precinct. For example, the collection of portions of the bit-plane codes may be a collection of the bit-plane codes from the MSB to the third MSB of all of the code blocks. Since the “portion” of the bit-plane code may be vacant, the content of the packet may be vacant codewise. The packet header includes information related to the codes included in the packet, so that each packet may be treated independently. Hence, the packet is a unit of the codes.

When all of the precincts (=all code blocks=all sub-bands) are collected, a portion of the codes of the entire image region, that is, a layer, is formed. For example, the portion of the codes of the entire image region may be the bit-plane codes from the MSB to the third MSB of the wavelet coefficients of the entire image region. The layer is roughly a portion of the bit-plane codes of the entire image, and for this reason, the picture quality can be improved if the number of layers that are decoded increases. In other words, the layer is a unit of the picture quality formed in the depth direction of the bits. When all of the layers are collected, all of the bit-plane codes of the entire image region are obtained.

FIG. 5, made up of part 1 and part 2, shows the layer and the packets included therein for a case where the decomposition level is two and the precinct size is equal to the sub-band size. Since the packet is in units of precincts, the packet extends over the sub-bands HL through HH if the precinct size is equal to the sub-band size. In FIG. 5, only some packets are surrounded by bold lines for convenience.

The operation of arranging the packets according to breaks of the packets and layers is referred to as code formation. As described above, the packet has four attributes, namely, an attribute indicating the component (symbol C) to which the packet belongs, an attribute indicating the resolution level (symbol R) to which the packet belongs, an attribute indicating the precinct or position (symbol P) to which the packet belongs, and an attribute indicating the layer (symbol L) to which the packet belongs. The arranging of the packets means the hierarchical arrangement of the packets according to the specified order of the attributes. The arranging order of the packets is called the progression order, and five kinds of progression orders are prescribed as shown in FIG. 6.

For example, in the case of the LRCP progression order, the packet arrangement (when encoding) and the analyzing (when decoding) are made by the following for-loop.

```
for (layer){
  for (resolution){
  for (component){
    for (precinct){
    when encoding: arrange packets
    when decoding: analyze packet attributes
    }
  }
  }
}
```

Each packet has a packet header, and the following information is written in the packet header.
whether or not the packet is vacant;
which code block is included in the packet;
the number of zero bit-planes of each of the code blocks included in the packet;
the number of coding paths (or number of bit-planes) of each of the code block codes included in the packet; and
the code length of each of the code blocks included in the packet.

However, the layer number, the resolution number and the like are not written in the packet header. In order to discriminate the layer and the resolution of the packet when decoding, the for-loop described above is formed from the progression order written in a COD marker within a main header, and the break of the packet is discriminated from a sum of the code lengths of each of the code blocks included in the packet, in order to obtain the position within the for-loop where each packet was handled. This means that, as long as the code length within the packet header is read out, it is possible to detect the next packet, that is, to access an arbitrary packet, without having to decode the entropy code itself.

As described above, the codes according to the JPEG2000 are accessible in units of packets. This means that it is possible to extract only the necessary codes from the original codes and generate new codes from the extracted codes. This also means that it is possible to decode only the codes partially extracted from the original codes if necessary.

For example, when displaying a large image that is within a server system on a client system, it becomes possible to receive from the server system and decode only the codes necessary for the picture quality, only the codes necessary for the resolution, only the codes of the position to be viewed, and only the codes of the components to be viewed. A protocol for receiving only the necessary codes from the JPEG2000 codes within the server system is presently in the process of being standardized as the JPIP (JPEG2000 Interactive Protocol).

According to the proposed JPIP, the client system can specify the region to be plotted and the picture quality with respect to the server system. When the region is specified, the server system sends the packets of the precincts covering the specified region. In other words, it is possible to send only the packets of the necessary precincts in the following loop.

for (precinct){
analyze packet
}

In addition, when the picture quality is specified at the same time, it is possible to send only the packets of the necessary layers in the following loop.

```
for (layer){
...
  for (precinct){
    analyze packet
  }
...
}
```

The protocol for partially accessing the hierarchical image may be found in FlashPix which is a multi-resolution representation of the image, and in IIP (Internet Imaging Protocol) which is the accessing protocol therefore. A Japanese Laid-Open Patent Application No. 11-205786 proposes a method related to the IIP. Further, a Japanese Laid-Open Patent Application No. 2003-23630 proposes a cache model and the like of the JPIP.

With respect to the JPM encoded data, if only the desired portion of the image is to be accessed via the JPIP, it is desirable to be able to send and receive only the codes of the desired portion for each of the foreground, the mask and the background. However, the conventional JPM encoded data does not take such a partial access into consideration. For example, the mask data is binary image data in most cases, but conventionally, the JPM employs the encoding techniques for binary images, such as the MMR and JBIG popularly employed in facsimile communication, to compress the mask data that is the binary image data, thereby making the partial access impossible. Similarly, the partial access was impossible for the MRC encoded data.

### SUMMARY OF THE INVENTION

An encoding method and encoding apparatus are described. In one embodiment, an encoding method comprises acquiring background data, and at least one pair of foreground data and mask data, that are obtained by decomposing original image data; and encoding the background data, the foreground data and the mask, including JPEG2000encoding using tile division or precinct division with respect to the mask data.

### BRIEF DESCRIPTION OF THE DRAWINGS

FIG. 1 is a diagram for illustrating an original image, a foreground, a mask and a background according to the MRC;

FIG. 2 is a block diagram for illustrating a sequence of the encoding process according to the JPEG2000;

FIG. 3 is a diagram showing the relationship of an image, tiles, precincts and code blocks according to the JPEG2000;

FIG. 4 is a diagram showing an example of the sub-band division and the resolution level of each sub-band according to the JPEG2000;

FIG. 5 is a diagram for illustrating the layer division and the packets included in the layers according to the JPEG2000;

FIG. 6 is a diagram for illustrating the progression orders of the JPEG2000;

FIG. 7 is a system block diagram for illustrating an embodiment of the present invention;

FIG. 8 is a system block diagram showing a computer that can realize the encoding apparatus and the encoding method according to the present invention;

FIG. 9 is a diagram for illustrating a format of MRC encoded data;

FIG. 10 is a diagram for illustrating a format of JPM encoded data;

FIG. 11 is a diagram for illustrating original image data decomposed into a background, a pair of foreground data 1 and mask data 1, and a pair of foreground data 2 and mask data 2;

FIG. 12 is a flow chart for illustrating the process of the first embodiment of the present invention;

FIG. 13 is a diagram showing a Sobel operator;

FIG. 14 is a diagram showing the Sobel operator;

FIG. 15 is a diagram schematically showing division and encoding of the foreground and the mask in the first embodiment of the present invention;

FIG. 16 is a diagram schematically showing the division and encoding of the foreground and the mask in a second embodiment of the present invention;

FIG. 17 is a flow chart for illustrating the process of a third embodiment of the present invention;

FIG. 18 is a diagram schematically showing the division and encoding of the foreground and the mask in the third embodiment of the present invention;

FIG. 19 is a diagram schematically showing the division and encoding of the foreground and the mask in a fourth embodiment of the present invention;

FIG. 20 is a diagram schematically showing an example of the division and encoding of the foreground and the mask;

FIG. 21 is a diagram schematically showing an example of the division and encoding of the foreground and the mask;

FIG. 22 is a diagram schematically showing an example of the division and encoding of the foreground, the mask and the background;

FIG. 23 is a diagram schematically showing an example of the division and encoding of the foreground, the mask and the background;

FIG. 24 is a diagram schematically showing an example of the division and encoding of the foreground, the mask and the background; and

FIG. 25 is a diagram schematically showing an example of the division and encoding of the foreground, the mask and the background.

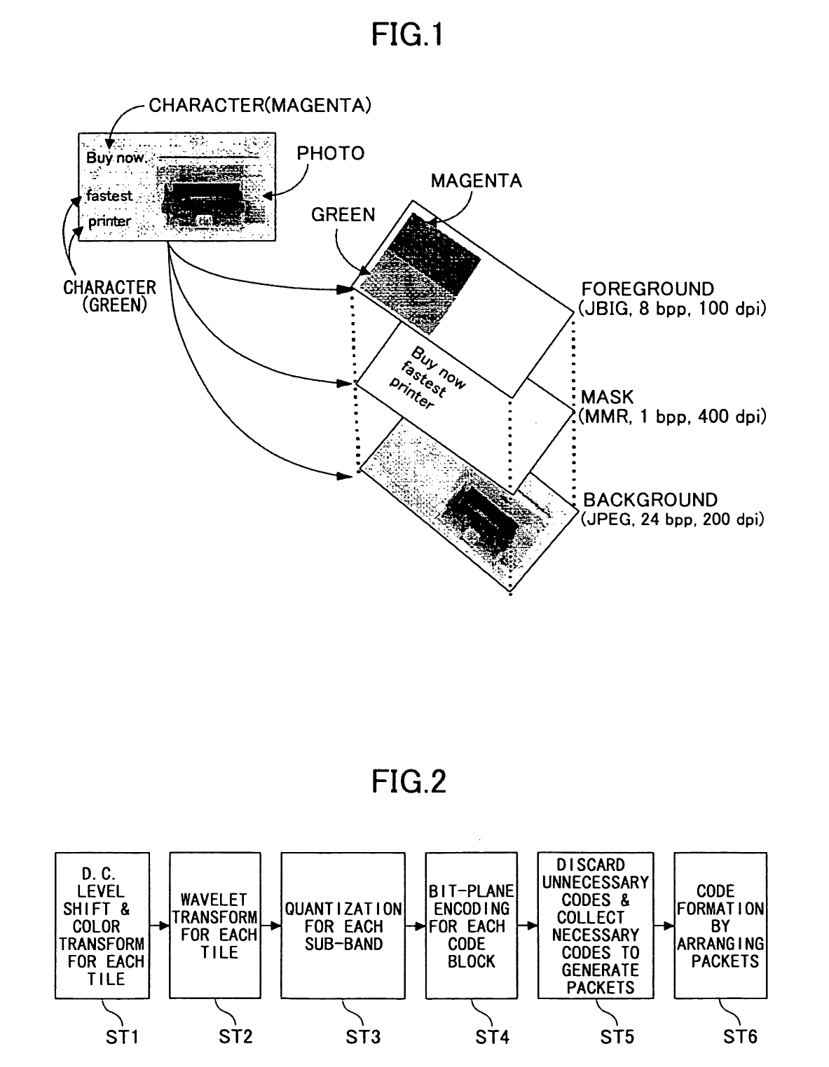

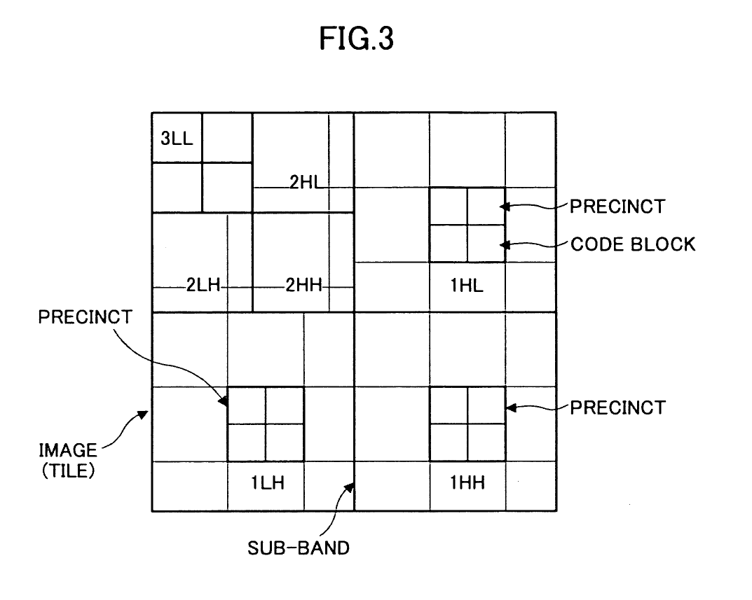

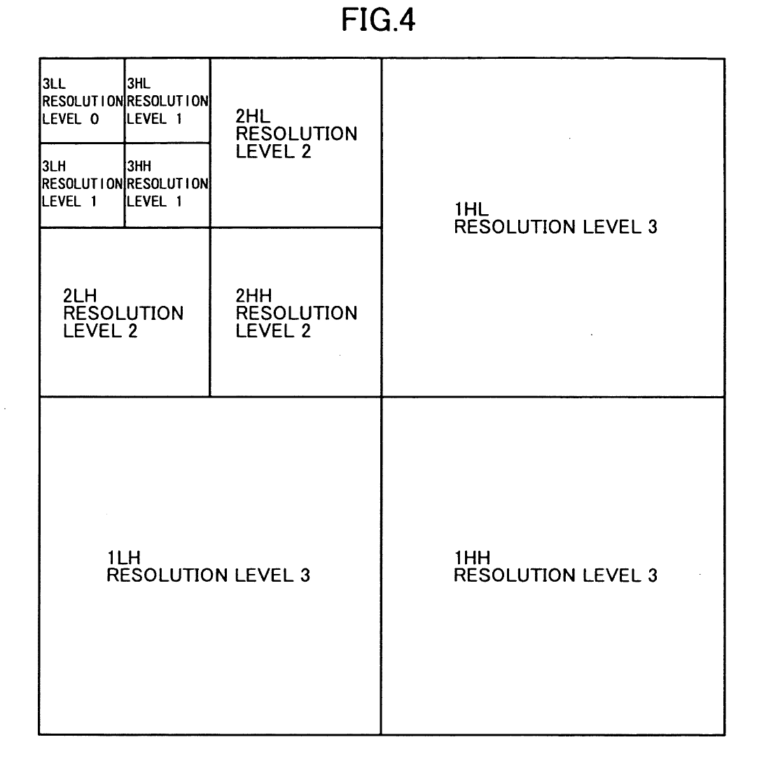

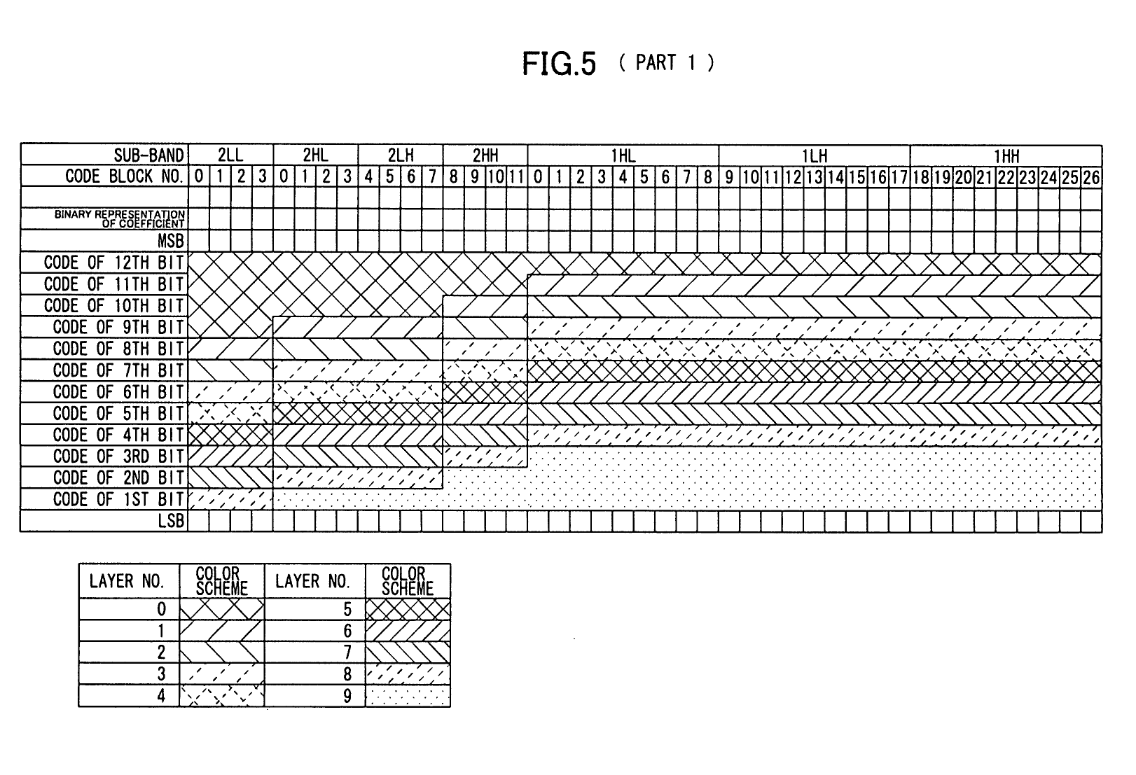

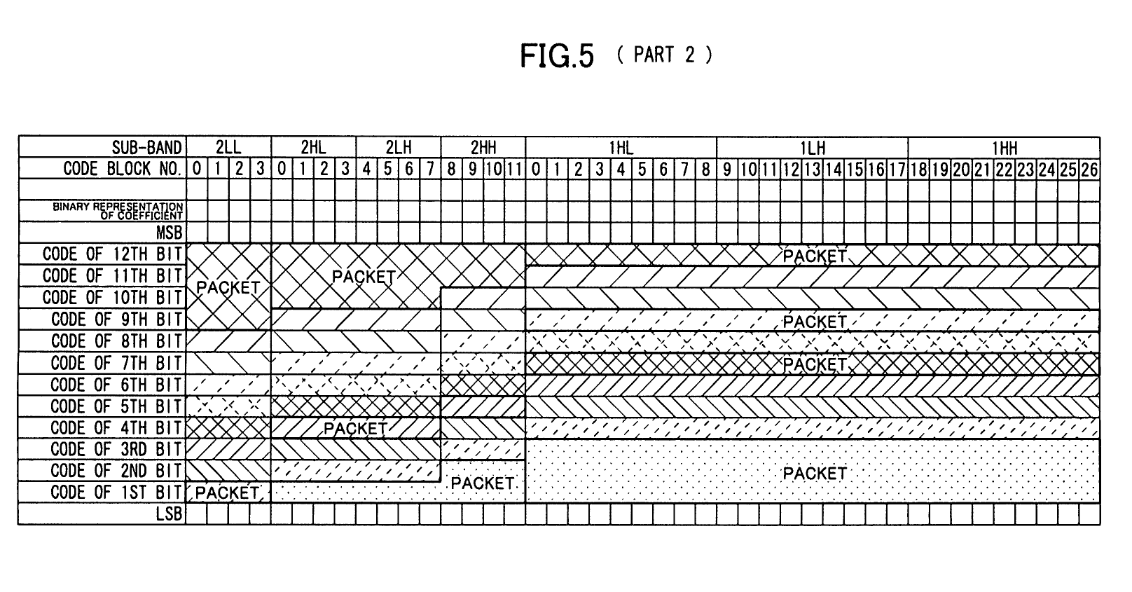

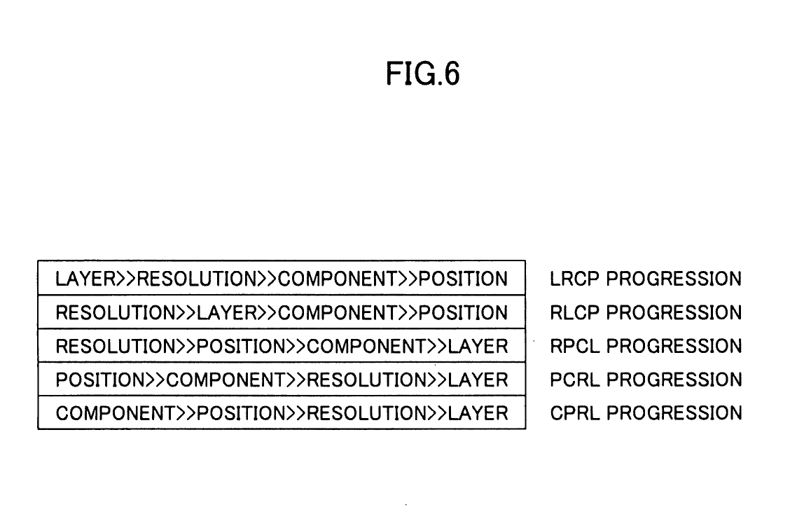

### DESCRIPTION OF THE PREFERRED EMBODIMENTS

Accordingly, one or more embodiments of the present invention include a novel and useful encoding method and encoding apparatus, computer program and computer-readable storage medium, in which the problems described above are suppressed or overcome.

Other more specific embodiments of the present invention include an encoding method, an encoding apparatus, a computer program and a computer-readable storage medium, which can generate encoded data that enables satisfactory partial access, when encoding the background data and one or a plurality of pairs of the foreground data and the mask data that are obtained by decomposing the original image data.

Still other embodiments of the present invention include an encoding method or an encoding apparatus, which acquires background data, and at least one pair of foreground data and mask data, that are obtained by decomposing original image data, and encodes the background data, the foreground data and the mask data acquired by the data acquiring step, wherein the encoding performs a JPEG2000 encoding using tile division or precinct division with respect to the mask data. According to the encoding method or the encoding apparatus of the present invention, it is possible to facilitate the partial access with respect to the mask data, and improve the encoding efficiency of the mask data.

Further embodiments of the present invention include an encoding method or an encoding apparatus, which acquires background data, and at least one pair of foreground data and mask data, that are obtained by decomposing original image data, and encodes the background data, the foreground data and the mask data acquired by the data acquiring step, wherein the encoding divides the mask data into a plurality of region parts, and independently encodes each of the region parts. According to the encoding method or the encoding apparatus of the present invention, it is possible to facilitate the partial access with respect to the mask data, and improve the encoding efficiency of the mask data.

Another embodiment of the present invention includes an encoding apparatus comprising a data acquiring unit to acquire background data, and at least one pair of foreground data and mask data, that are obtained by decomposing original image data; an encoding unit to encode the background data, the foreground data and the mask data acquired by the data acquiring part; and a code formation unit to form encoded data having a predetermined format by combining the background data, the foreground data and the mask data encoded by the encoding unit, wherein the encoding unit divides the mask data into a plurality of region parts, and independently encodes each of the region parts, and the code formation part causes sharing of codes of the foreground data with codes of the plurality of region parts of the mask data. According to the encoding apparatus of the present invention, it is possible to avoid dividing the foreground image into a plurality of separate images without increasing the amount of the codes.

Other embodiments and further features of the present invention will be apparent from the following detailed description when read in conjunction with the accompanying drawings.

In the present invention, “background data and at least one pair of foreground data and mask data that are obtained by decomposing original image data” are defined as being used to reproduce the original image data by the finally combined background data n+1, by repeating a procedure of combining the background data i+1 for i=1 to i=n, by a method that selects one of the foreground data i and the background data i for each pixel according to the mask data i or, by a method of obtaining a weighted average of the foreground data i and the background data i for each pixel, for the background data 1 and n pairs the foreground data i and the mask data i that are obtained by decomposing the original image data for i=1, 2, . . . , n, where n is an integer greater than or equal to 1.

In this specification and drawings, the background data, the foreground data and the mask data are also respectively referred to in abbreviated form as the background, the foreground and the mask.

Two kinds of approaches are conceivable to enable the partial access to send and receive only codes of a desired portion of the image. A first conceivable approach is to take measures to apply an encoding technique capable of making the partial access, even if the mask data is binary image data. Hence, the present inventor found that according to the JPM, the JPEG2000 is applicable even with respect to the mask data.

As described above with respect to the prior art, the tile division and the precinct division are applicable to the JPEG2000. In addition, when the JPEG2000 encoding using the tile division or the precinct division is applied to the mask data, it becomes possible to make access to the codes of the desired portion. Moreover, according to the JPEG2000, it is possible to perform an encoding that does not apply the wavelet transform. In the case where the mask data is binary image data, it is possible, in general, to reduce the code size of the mask data if the wavelet transform is not applied. Furthermore, even in the case where the mask data is multi-level image data, if the mask data only takes three values, for example, and the absolute values of the three values are limited to 0 or 2ⁿ, where n is an integer, the encoding efficiency is generally good when the wavelet transform is not applied because bit-planes other than the three bit-planes are filled by 0's.

On the other hand, a second conceivable approach is to divide the mask data into a plurality of region parts and to independently encode the region parts by treating the region parts as separate images. When the mask data itself is divided into the plurality of region parts or the separate images, no inconveniences will be introduced because the JPM is provided with a mechanism for integrating the individual region parts when decoding. In this case, the encoding technique with respect to the mask data is not limited to the technique capable of the tile division and the precinct division as is the case of the JPEG2000.

The present invention is based on the above findings of the present inventor.

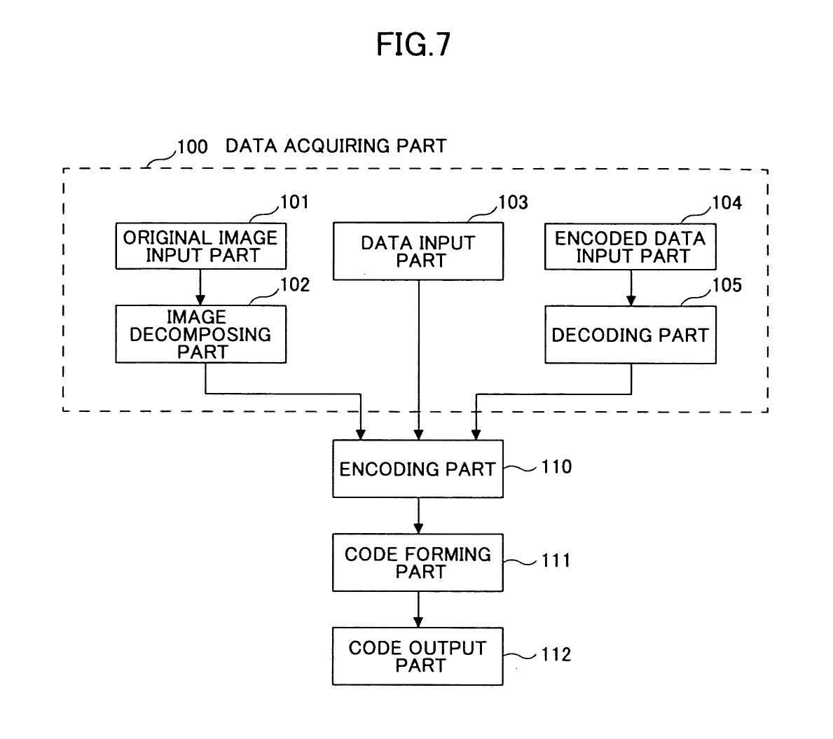

FIG. 7 is a system block diagram for illustrating an embodiment of the present invention. An encoding apparatus shown in FIG. 7 includes a data acquiring unit 100, an encoding unit 110, a code forming unit 111 and a code output unit 1 12.

The data acquiring unit 100 acquires the background data and at least one pair of the foreground data and the mask data that are obtained by decomposing the original image data. The encoding unit 110 independently encodes the background data, the foreground data and the mask data that are acquired by the data acquiring unit 100. It is inconvenient to independently treat the codes of the background, the codes of the foreground and the codes of the mask data that are acquired by the data acquiring unit 100, and thus, the codes of the background, the codes of the foreground and the codes of the mask data are normally collected into a single file having a predetermined format. Accordingly, in this embodiment of the encoding apparatus, the code forming unit 111 combines the codes of the background, the codes of the foreground and the codes of the mask data that are acquired by the data acquiring unit 100, and adds a header that is required, in order to form encoded data (or file) having the JPM format or the MRC format. The code output unit 112 outputs the encoded data from the code forming unit 111, in order to output the encoded data to an external apparatus (not shown) or, to write the encoded data into an internal storage unit (not shown) of the encoding apparatus.

In this embodiment, the data acquiring unit 100 includes an original image input unit 101, an image decomposing unit 102, a data input unit 103, an encoded data input unit 104 and a decoding unit 105. The original image input unit 101 inputs original image data related to an original image, from outside the data acquiring unit 100 or the encoding apparatus. The image decomposing unit 102 decomposes the original image data that is input by the original image input unit 101 into background data and one or a plurality of “pairs of foreground data and mask data”. The data input unit 103 inputs background data and one or a plurality of pairs of foreground data and mask data that are obtained in advance by decomposing the original image data, from outside the data acquiring unit 100 or the encoding apparatus. The encoded data input unit 104 inputs JPM or MRC encoded data from outside the data acquiring unit 100 or the encoding apparatus. The decoding unit 105 decodes the encoded data input by the encoded data input unit 104, and generates the background data and one or a plurality of pairs of the foreground data and the mask data. The data acquiring unit 100 may be formed solely of the original image input unit 101 and the image decomposing unit 102 or, solely of the data input unit 103 or, solely of the encoded data input unit 104 and the decoding unit 105. The data acquiring unit 100 having any of such structures also falls within the scope of the present invention.

The blocks shown in FIG. 7 correspond to steps of the encoding method according to the present invention. The data acquiring unit 100 corresponds to a data acquiring step, the encoding unit 110 corresponds to an encoding step, the code forming unit 111 corresponds to a code forming step, and the code output unit 112 corresponds to a code output step. The data acquiring unit 100 may correspond solely to steps corresponding to the original image input unit 101 and the image decomposing unit 102 or, solely to a step corresponding to the data input unit 103 or, solely to steps corresponding to the encoded data input unit 104 and the decoding unit 105.

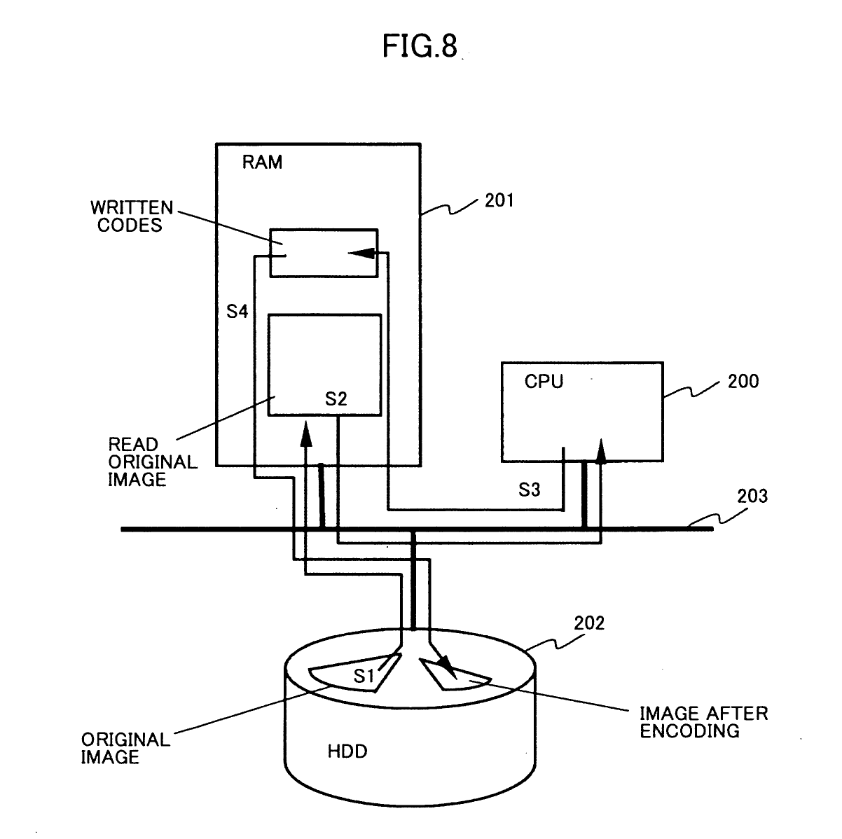

The encoding apparatus and the encoding method according to the present invention may be realized by a computer shown in FIG. 8. FIG. 8 is a system block diagram showing the computer that can realize the encoding apparatus and the encoding method according to the present invention. The computer shown in FIG. 8 has a generally known structure including a CPU 200, a memory 201, a hard disk drive (HDD) 202 and the like that are mutually connected via a system bus 203. One or a plurality of computer programs, such as application programs and device drivers or the like, when executed by the CPU 200, causes the computer to perform the encoding method and to function as the encoding apparatus.

The program that causes the computer to function as the data acquiring unit (or step or procedure) 100, the encoding unit (or step or procedure) 110, the code forming unit (or step or procedure) 111, and the code output unit (or step or procedure) 112 is normally stored in the HDD 202, and is loaded into the memory 201 when the program needs to be executed by the CPU 200. A computer-readable storage medium according to the present invention, which stores the program according to the present invention, it not limited to a particular type of recording medium. For example, magnetic recording media, optical recording media, magneto-optical recording media and semiconductor memory devices may be used as the recording medium forming the computer-readable storage medium.

When using the original image input unit 101 and the image decomposing unit 102 of the data acquiring unit 100, the process of the computer is performed by the following steps S1 through S4 shown in FIG. 8.
S1: The original image data stored in the HDD 202 is stored in the memory 201 in response to an instruction from the CPU 200.
S2: The CPU 200 reads the original image data in the memory 201, generates the background data and the one or plurality of pairs of the foreground data and the mask data, encodes each of these data into codes, and generates encoded data having the JPM format or the MRC format by integrating the generated codes.
S3: The CPU 200 writes the encoded data into another region in the memory 201.
S4: The encoded data in the memory 201 is stored in the HDD 202 in response to an instruction from the CPU 200.

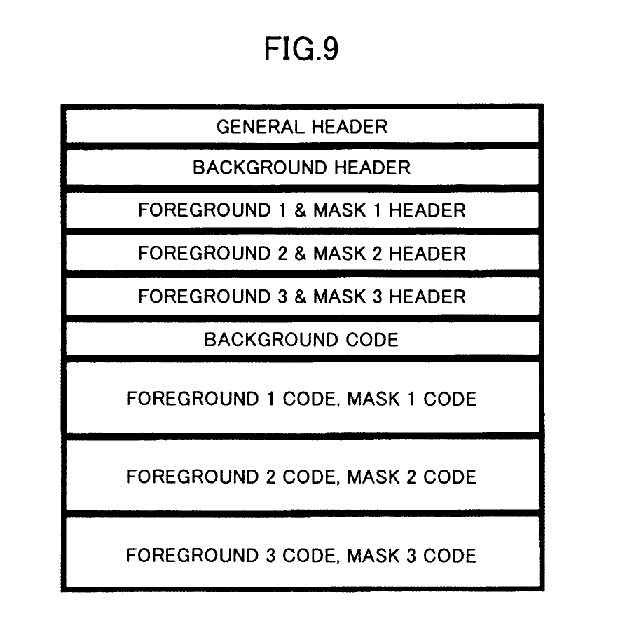

FIG. 9 is a diagram for illustrating the format of the MRC encoded data (or encoded file). As shown in FIG. 9, the MRC encoded data includes a general header for indicating that the encoded data is the MRC encoded data, a background header for indicating the background code, one background code, one or a plurality of foreground and mask headers for indicating the pair of foreground code and mask code, and one or a plurality of pairs of foreground code and mask code. In the particular case shown in FIG. 9, three foreground and mask headers are provided, and three pairs of foreground code and mask code are provided.

As described above, the JPM is the MRC type encoding technique that permits the JPEG2000 as the encoding technique for the background data, the foreground data and the mask data. For this reason, the encoded data of the JPM has a format similar to the MRC format, including a header and a sequence of codes following the header.

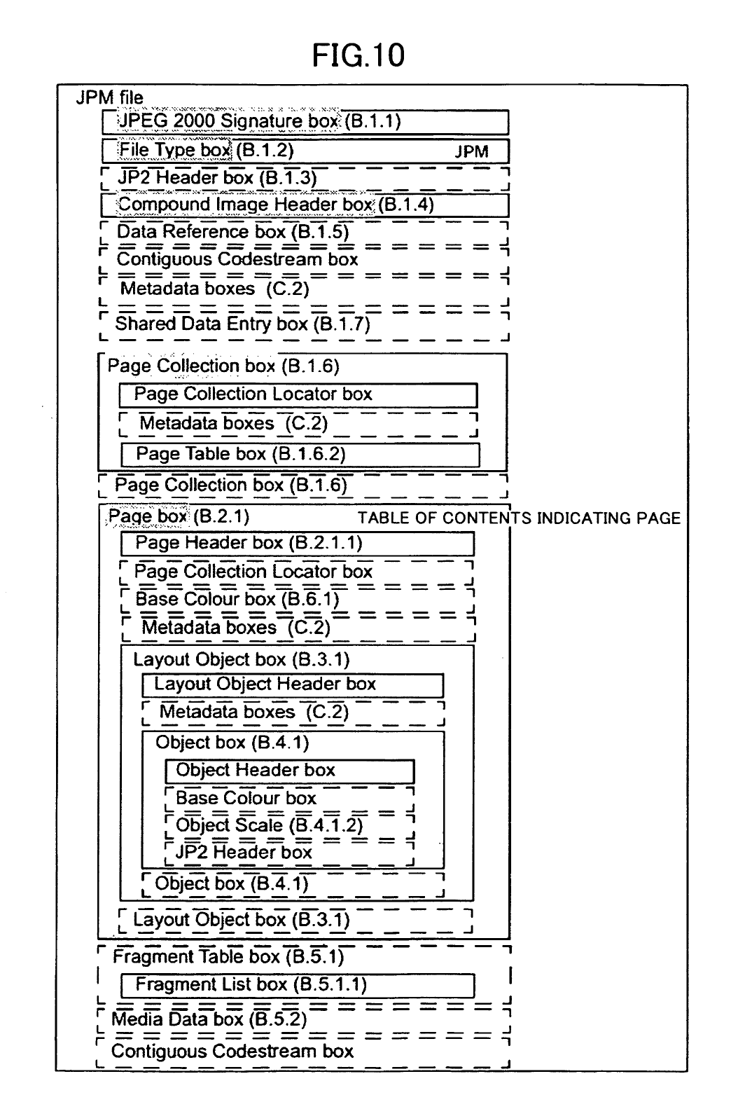

FIG. 10 is a diagram for illustrating the format of the JPM encoded data. In FIG. 10, parts indicated by dotted lines are optional, and thus, a brief description will be given mainly of parts indicated by solid lines. In FIG. 10, a “JPEG2000 Signature Box” is a general header for indicating that the corresponding code belongs to the JPEG2000 family. A “File Type Box” is a general header for indicating that the corresponding code employs the JPM format. A “Compound Image Header Box” is a kind of table of contents for indicating the order of each of the pages when the corresponding code is made up of multiple pages. A “Page Box” is a general header for indicating the resolution or the like of the page. The “page” is a canvas on which the images are to be successively overlapped or combined, and has the same size as the final image that is obtained after the combining ends. In the case of the JPM, “layout objects” that are formed by pairs of the foreground and the mask are successively plotted in the page. A “layout Object box” indicates the size, position and the like of the foreground and the mask. A “Media Data box” and a “Continuous Codestream box” are portions including the codes of the foreground and the mask. In the JPM, the background (Base Page) is treated as an initial page in which the layout object is plotted.

Next, a more detailed description will be given of various embodiments of the present invention. Unless specifically indicated, it is assumed in the following embodiments that, in the data acquiring unit 100 shown in FIG. 7, the original image data is input by the original image input unit 101, and the original image data is decomposed into the background data and one or a plurality of layout objects (one or a plurality of pairs of foreground data and mask data) by the image decomposing unit 102.

### First Embodiment

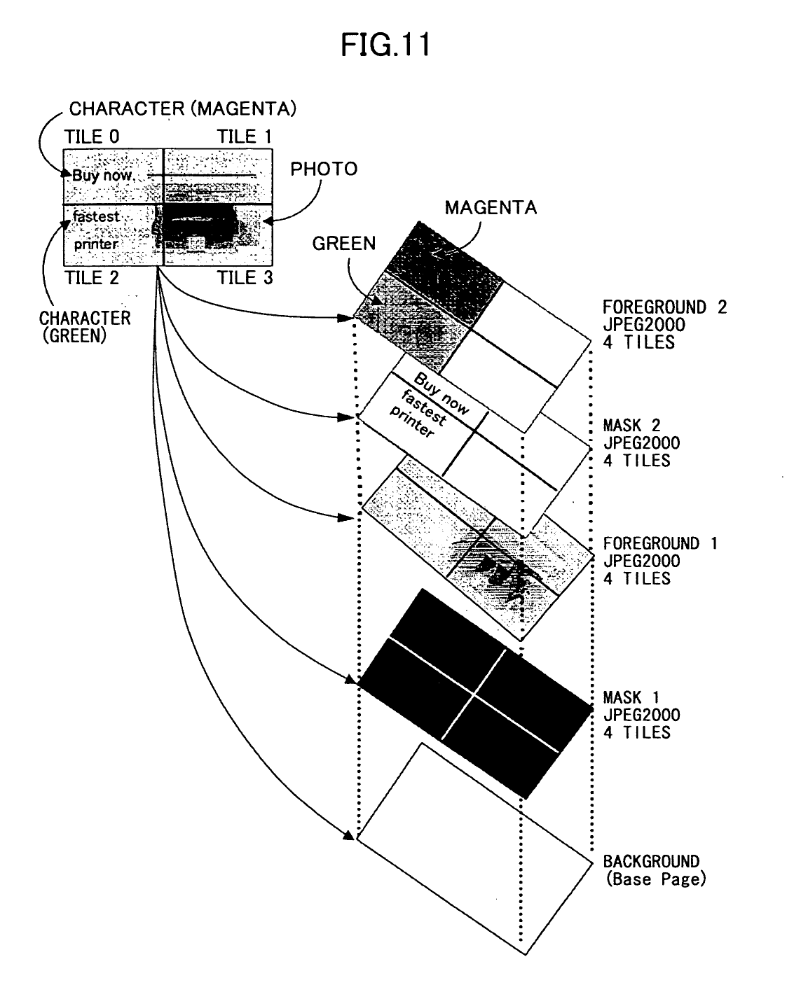

In this first embodiment, the original image data is decomposed into the background data, the pair of the foreground data 1 and the mask data 1, and the pair of the foreground data 2 and the mask data 2, as schematically shown in FIG. 11. FIG. 11 is a diagram for illustrating original image data decomposed into the background, the pair of the foreground data 1 and the mask data 1, and the pair of the foreground data 2 and the mask data 2.

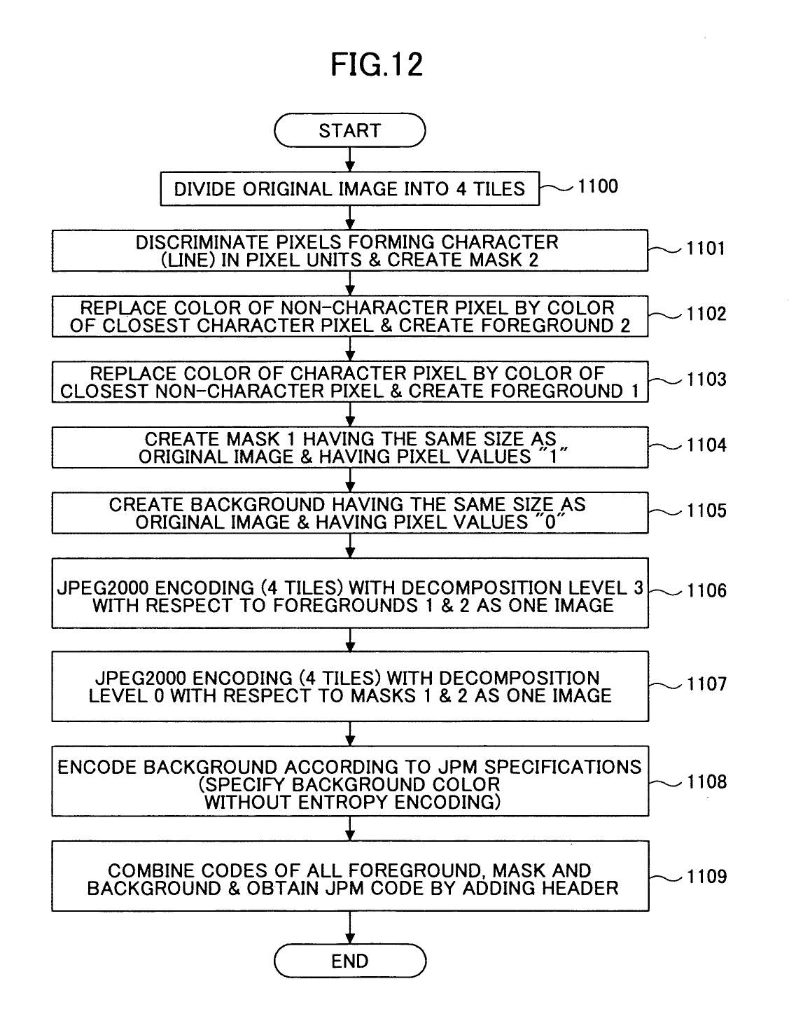

FIG. 12 is a flow chart for illustrating the process of the first embodiment of the present invention. In FIG. 12, steps 1100 through 1105 are performed by the image decomposing unit 102 within the data acquiring unit 100, and steps 1106 through 1108 are performed by the encoding unit 110. A step 1109 is performed by the code forming unit 111. In other words, the image decomposing unit 102 includes parts or means for performing steps 1100 through 1105, and the encoding unit 110 includes parts or means for performing steps 1106 through 1108.

First, step 1100 divides the input original image data into four tiles, as shown in FIG. 11. The number of tiles into which the original image data is divided may be increased or decreased from four if necessary. In this embodiment, the tile is a minimum divisionally accessible region with respect to the encoded data, and thus, the number of tiles into which the original image data is to be divided may be selected based on the size of the minimum divisionally accessible region and the size of the original image data.

With respect to each pixel of the original image data, step 1101 discriminates whether the pixel is a character pixel forming the character (or line) or, the pixel is a non-character pixel forming other than the character (or line), and creates a binary mask data 2 having the same size as the original image data. In the binary mask data 2, the value at a position corresponding to the character pixel is set to “1”, and the value at a position corresponding to the non-character pixel is set to “0”. The pixels of the mask data 2 and the pixels of the original image data correspond 1:1, and the mask data 2 has a form that is divided into tiles at the same division boundaries as the original image data, as shown in FIG. 11.

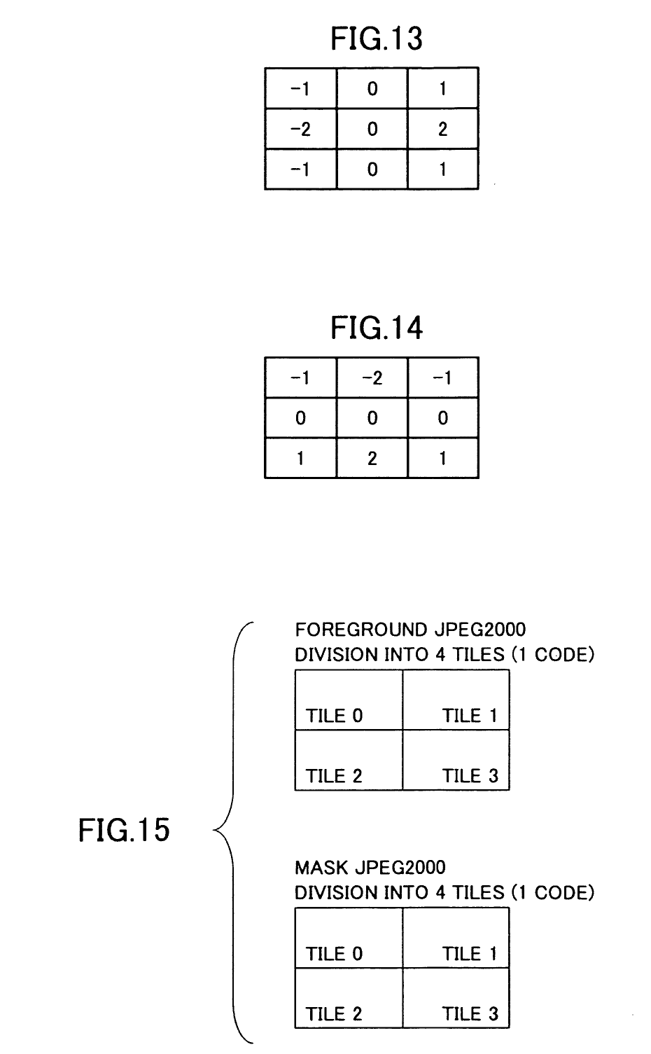

The character pixel and the other non-character pixel may be discriminated by any known image region discriminating technique, and for example, the following technique is used in this embodiment. First, with respect to each pixel of the original image data, a known Sobel filter is used as an edge detection operator. That is, with respect to 3×3 pixels having a target pixel at the center, a first weighting matrix (or Sobel operator) shown in FIG. 13 is multiplied to calculate a sum HS, and a second weighting matrix (or Sobel operator) shown in FIG. 14 is multiplied to calculate a sum VS. FIGS. 13 and 14 are diagrams respectively showing the Sobel operator. A value (HS²+VS²)^{1/2} is output from the Sobel filter as an output value with respect to the target pixel. If the output value of the Sobel filter is greater than or equal to a predetermined threshold value th (for example, th=30), it is determined that the target pixel is a character pixel and “1” is set at the corresponding pixel position of the mask data, while “0” is otherwise set at the corresponding pixel position of the mask data. By repeating a similar procedure with respect to all of the pixels, it is possible to create the mask data 2. The discrimination result of the step 1101 indicating whether the target pixel is the character pixel or the non-character pixel is also utilized in the steps 1102 and 1103.

Step 1102 creates the multi-level foreground data 2 by replacing the color of the non-character pixel of the original image data by the color of the character pixel located at the position closest to the non-character pixel. In this case, the original image data itself is already stored. The foreground data 2 has the same size as the original image data. The pixels of the foreground data 2 and the pixels of the original image data correspond 1:1, and the foreground data 2 has a form that is divided into tiles at the same division boundaries as the original image data, as shown in FIG. 11.

Step 1103 creates the multi-level foreground data 1 by replacing the color of the character pixel of the original image data by the color of the non-character pixel located at the position closest to the character pixel. The foreground data 1 has the same size as the original image data. The pixels of the foreground data 1 and the pixels of the original image data correspond 1:1, and the foreground data 1 has a form that is divided into tiles at the same division boundaries as the original image data, as shown in FIG. 11.

Step 1104 creates the binary mask data I in which “1” is set to all of the pixel positions. The mask data 1 has the same size as the original image data. The pixels of the mask data 1 and the pixels of the original image data correspond 1:1, and the mask data 1 has a form that is divided into tiles at the same division boundaries as the original image data, as shown in FIG. 11.

Step 1105 creates a multi-level background data in which “0” (or white) is set to all of the pixel positions. This background data has the same size as the original image data.

As a result, the original image data is decomposed into the background data, the pair of foreground data 1 and the mask data 2, and the pair of the foreground data 1 and the mask data 2, that are used to reproduce the original image data.

Next, step 1106 performs the JPEG2000 encoding, with respect to the multi-level foreground data 1 and the multi-level foreground data 2, using the tile division. FIG. 15 is a diagram schematically showing the division and encoding of the foreground and the mask in the first embodiment of the present invention. As shown schematically in the upper portion of FIG. 15, each foreground data is divided into four tiles and encoded, but since each foreground data is treated as one image data, one code is generated with respect to each foreground data. By such a tile division, the codes of the foreground data 1 and 2 can make partial access with respect to the top left, the top right, the bottom left and the bottom right of the image. According to this encoding, the wavelet transform is performed up to the decomposition level 3, but the number of decomposition levels may be increased or decreased if necessary.

Step 1107 performs the JPEG2000 encoding, with respect to the binary mask data 1 and the binary mask data 2, using the tile division. As shown schematically in the lower portion of FIG. 15, each mask data is divided into four tiles and encoded, but since each mask data is treated as one image data, one code is generated with respect to each mask data. By such a tile division, the codes of the mask data 1 and 2 can make partial access with respect to the top left, the top right, the bottom left and the bottom right of the image. According to this encoding, no wavelet transform is performed (that is, the decomposition level is 0), but the wavelet transform may be performed if necessary.

The step 1108 encodes the background data according to the JPM specifications. In other words, the background color is specified as the code, without performing an entropy encoding.

The last step 1109 forms the encoded data having the JPM format, by combining the codes of the foreground data 1 and 2, the mask data 1 and 2, and the background data and adding the necessary headers.

In this embodiment, the tile boundaries, that is, the division boundaries match for the pair of foreground data 1 and the mask data 1 (layout object 1), and the division boundaries also match for the pair of foreground data 1 and the mask data 1 (layout object 1) and the pair of foreground data 2 and the mask data 2 (layout object 2), as described above.

Step 1100 of this embodiment divides the original image data into the tiles. However, in a modification of this embodiment of the present invention, the division into the tiles may be made in the encoding steps 1106 and 1107.

In other words, in the data acquiring unit 100, the process of the steps 1101 through 1105 becomes unnecessary if the data input unit 103 directly inputs the background, the foreground and the mask that are obtained by decomposing the original image data or, if the encoded data input unit 104 inputs the encoded data and the decoding unit 105 decodes the input encoded data.

### Second Embodiment

In this second embodiment of the present invention, the original image data is decomposed into the background data 1, the foreground data 1 and 2, and the mask data 1 and 2, as schematically shown in FIG. 11, but a precinct division is used in place of the tile division.

The process of this second embodiment of the present invention in general is similar to that of the flow chart shown in FIG. 12 for the first embodiment of the present invention. Accordingly, a description will be given of the process of this second embodiment by also referring to the flow chart of FIG. 12.

In this second embodiment, no process (step 1100) for dividing the original image data into the tiles is performed.

The process (step 1101) for creating the mask data 2, the process (step 1102) for creating the foreground data 2, the process (step 1103) for creating the foreground data 1, and the process (step 1104) for creating the mask data 1 are similar to those shown in FIG. 12, except that no tile division is performed. The process (step 1105) for creating the background data is the same as that shown in FIG. 12.

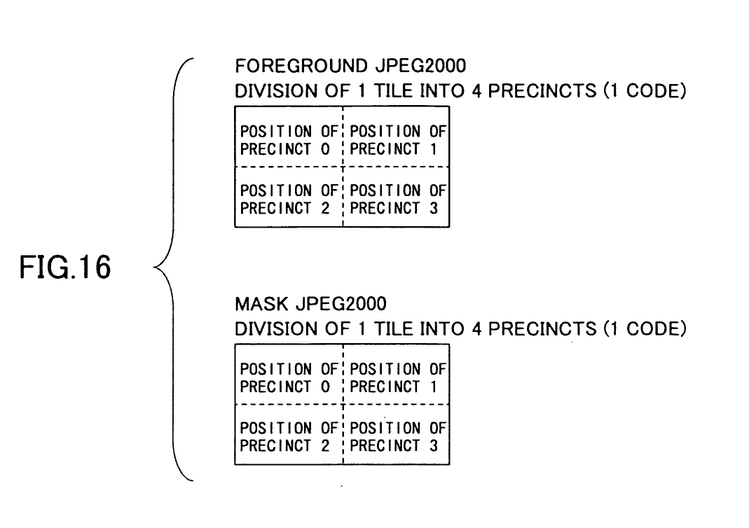

In the process (step 1106) for performing out the JPEG2000 encoding with respect to the foreground data 1 and 2, no tile division is made, but instead, the precinct division is made as schematically shown in the upper portion of FIG. 16, in order to divide the sub-band into four precincts. FIG. 16 is a diagram schematically showing the division and encoding of the foreground and the mask in this second embodiment of the present invention. Using such a precinct division, the codes of the foreground data 1 and 2 can make partial access with respect to the top left, the top right, the bottom left and the bottom right of the image.

In addition, in the process (step 1107) for performing the JPEG2000 encoding with respect to the mask data 1 and 2, no tile division is made, but instead, the precinct division is made as schematically shown in the lower portion of FIG. 16, so as to divide the sub-band into four precincts. Using such a precinct division, the codes of the mask data 1 and 2 can make partial access with respect to the top left, the top right, the bottom left and the bottom right of the image.

The processes (steps 1108 and 1109) for encoding the background data according to the JPM specifications and forming the encoded data having the JPM format are the same as those shown in FIG. 12.

In this embodiment, the precinct boundaries, that is, the division boundaries match for all of the foreground data 1 and 2 and the mask data 1 and 2, as may be seen from FIG. 16.

### Third Embodiment

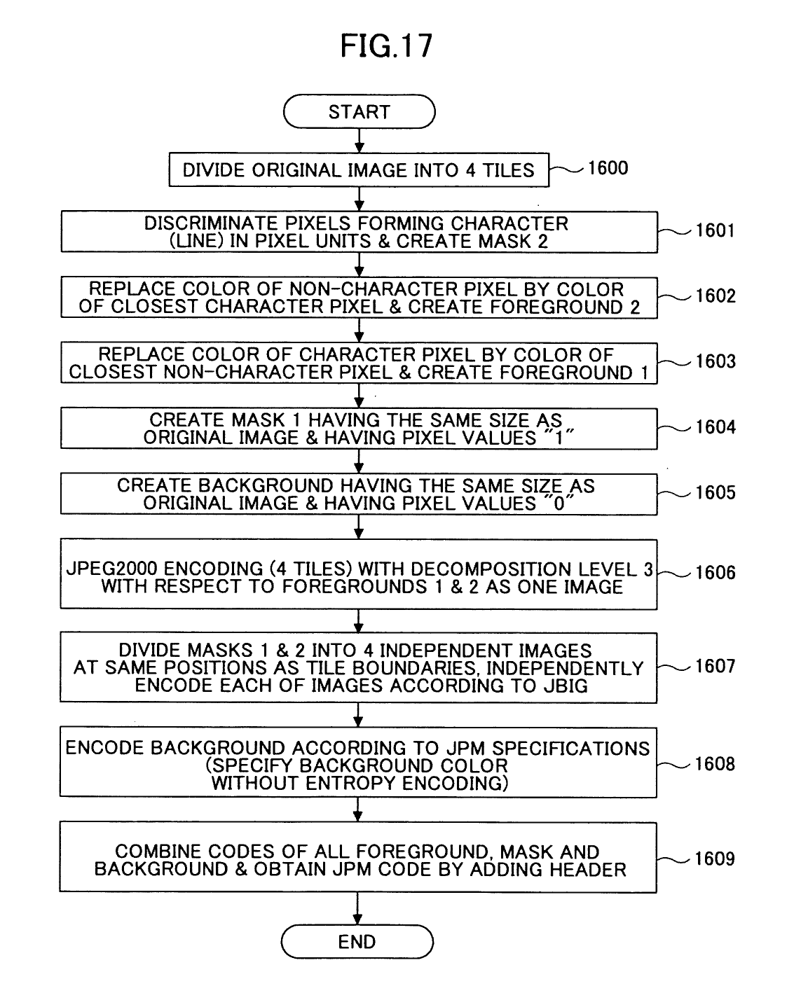

FIG. 17 is a flow chart for illustrating the process of a third embodiment of the present invention. In FIG. 17, steps 1600 through 1605 are performed by the image decomposing unit 102 within the data acquiring unit 100, and steps 1606 through 1608 are performed by the encoding unit 110. A step 1609 is performed by the code forming unit 111. In other words, the image decomposing unit 102 includes parts or means for performing the steps 1600 through 1605, and the encoding unit 110 includes parts or means for performing the steps 1606 through 1608.

The process of steps 1600 through 1605 are similar to the process of the corresponding steps 1100 through 1105 shown in FIG. 12, and a description thereof will be omitted.

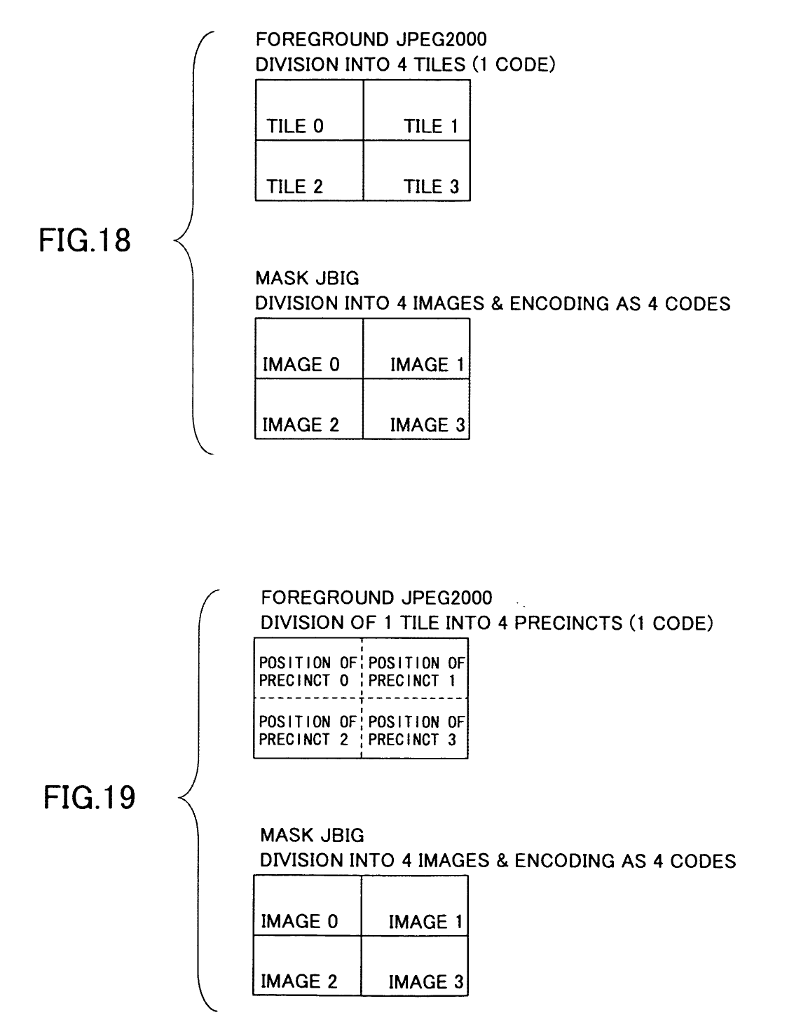

Step 1606 performs the JPEG2000 encoding, with respect to the multi-level foreground data 1 and the multi-level foreground data 2, using the tile division. FIG. 18 is a diagram schematically showing the division and encoding of the foreground and the mask in the third embodiment of the present invention. As shown schematically in the upper portion of FIG. 18, each foreground data is divided into four tiles and encoded, but since each foreground data is treated as one image data, one code is generated with respect to each foreground data. Using such a tile division, the codes of the foreground data 1 and 2 can make partial access with respect to the top left, the top right, the bottom left and the bottom right of the image. According to this encoding, the wavelet transform is performed up to the decomposition level 3, but the number of decomposition levels may be increased or decreased if necessary.

Step 1607 divides each of the binary mask data 1 and the binary mask data 2 at the same positions as the tile boundaries into four region parts (images 0, 1, 2 and 3), as shown schematically in the lower portion of FIG. 18, and performed the JBIG encoding independently for each of the region parts by treating each region part as an independent image. Accordingly, four codes are generated with respect to the mask data 1, and four codes are generated with respect to the mask data 2. Using such a division, the codes of the mask data 1 and 2 can make partial access with respect to the top left, the top right, the bottom left and the bottom right of the image.

Step 1608 encodes the background data according to the JPM specifications. In other words, the background color is specified as the code, without performing an entropy encoding.

Lastly, step 1609 forms the encoded data having the JPM format, by combining the codes of the foreground data 1 and 2, the mask data 1 and 2, and the background data and adding the necessary headers. But since each mask data is encoded as four independent images in this embodiment, the structure of the layout object is different from those of the first and second embodiment described above.

In other words, the four region parts (divided images) of the mask data 1 form four layout objects using the foreground data 1 that has been subjected to the tile division as shared data prescribed by the JPM. In addition, the four divided images of the mask data 2 form four layout objects using the foreground data 2 as the shared data.

In the case of the JPM, an identification (ID) is assigned to each layout object, and this ID is written in the “Layout Object Header box” shown in FIG. 10. As described above, the layout objects form “pairs” as a general rule, but if “separate objects for image and mask components” is specified as the “Layout Object Style”, it becomes possible to independently treat the foreground and the mask for the layout object having the same ID. In other words, it becomes as if the ID is assigned only to the foreground.

The ID of the shared layout object (the foreground in this particular case) is written in the “Shared Data Entry box,” which is the header for the entire JPM file. On the other hand, with regard to the layout object that is to share the foreground, the ID of the foreground is specified using the “Shared Data Reference box” to realize the sharing.

In this embodiment, the division boundaries also match for all of the foreground data 1 and 2, and the mask data 1 and 2, as may be seen from FIG. 18.

It is possible to omit step 1600, and perform the tile division in step 1606, as a modification of this third embodiment of the present invention.

As another modification of this third embodiment of the present invention, it is possible not to perform the tile division of the foreground data.

In other words, in the data acquiring unit 100, the process of steps 1601 through 1605 becomes unnecessary if the data input unit 103 directly inputs the background, the foreground and the mask that are obtained by decomposing the original image data or, if the encoded data input unit 104 inputs the encoded data and the decoding unit 105 decodes the input encoded data.

### Fourth Embodiment

The process of this fourth embodiment of the present invention in general is similar to that of the flow chart shown in FIG. 17 for the third embodiment of the present invention. Accordingly, a description will be given of the process of this fourth embodiment by also referring to the flow chart of FIG. 17.

In this fourth embodiment, no process (step 1600) for dividing the original image data into the tiles is performed.

The process (step 1601) for creating the mask data 2, the process (step 1602) for creating the foreground data 2, the process (step 1603) for creating the foreground data 1, and the process (step 1604) for creating the mask data 1 are similar to those shown in FIG. 17, except that no tile division is performed. The process (step 1605) for creating the background data is the same as that shown in FIG. 17.

In the process (step 1606) for performing the JPEG2000 encoding with respect to the foreground data 1 and 2, no tile division is made, but instead, the precinct division is made as schematically shown in the upper portion of FIG. 19, in order to divide the sub-band into four precincts. FIG. 19 is a diagram schematically showing the division and encoding of the foreground and the mask in this fourth embodiment of the present invention. By such a precinct division, the codes of the foreground data 1 and 2 can make partial access with respect to the top left, the top right, the bottom left and the bottom right of the image.

In addition, in the process (step 1607) for dividing each of the binary mask data 1 and the binary mask data 2 into four region parts (images 0, 1, 2 and 3), as shown schematically in the lower portion of FIG. 19, and performs the JBIG encoding independently for each of the region parts by treating each region part as an independent image. The division boundaries of the mask data 1 and 2 match the precinct boundaries of the foreground data 1 and 2. Accordingly, the codes of the foreground data 1 and 2 and the mask data 1 and 2 can make partial access with respect to the top left, the top right, the bottom left and the bottom right of the image.

The processes (steps 1608 and 1609) for encoding the background data according to the JPM specifications and forming the encoded data having the JPM format are the same as those shown in FIG. 17.

As another modification of this fourth embodiment of the present invention, it is possible not to perform the precinct division of the foreground data.

### Other Embodiments and Modifications

In the third and fourth embodiments of the present invention described above, it is also possible to also divide the foreground data into a plurality of region parts, and to independently encode each of the region parts.

According to the JPM, the pair of foreground data and mask data (layout object) is combined to one background data, and the combined image data is regarded as a new background data to combine with the next layout object. For this reason, when a plurality of layout objects exist, it is desirable that the division boundaries for the partial accessing matches for all of the layout objects. In this case, it is possible to improve the partial accessing to the foreground data and the mask data when a plurality of pairs of the foreground data and the mask data exist.

In the first through fourth embodiments of the present invention described above, all of the sizes and boundaries of the foreground and the mask match. However, it is of course possible to match the division boundaries of the foreground and the mask, and make the division sizes of the foreground and the mask different.

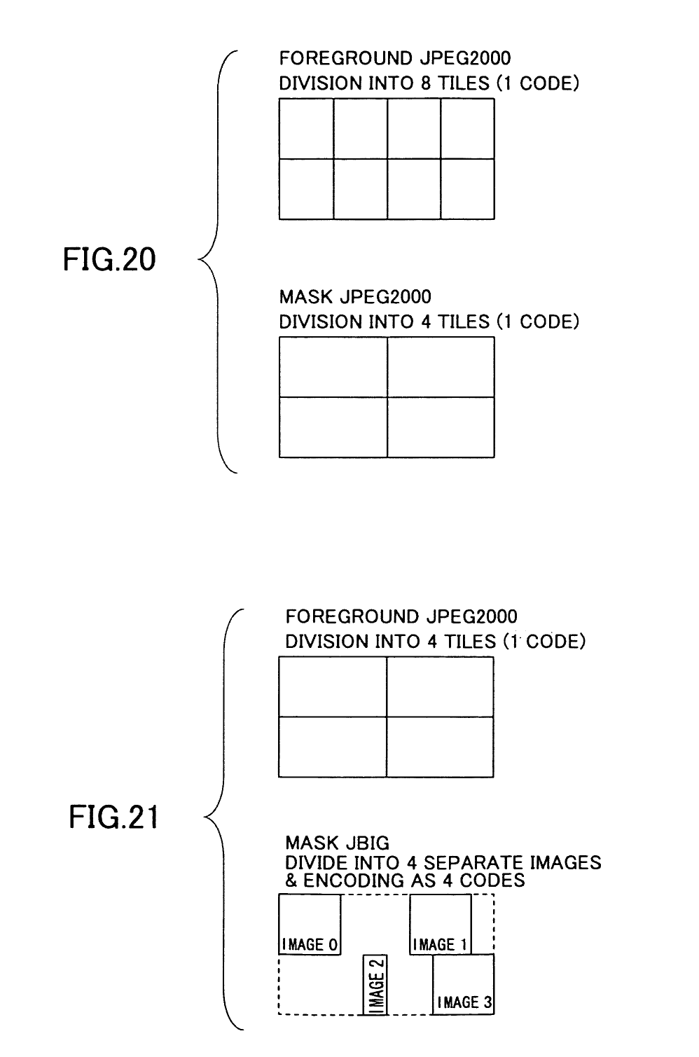

For example, in another embodiment of the present invention, the size of the divided region of the foreground (or mask) is made equal to an integer multiple of the size of the divided region of the mask (or the background). In other words, as schematically shown in FIG. 20, the foreground may be divided into eight tiles, and the mask may be divided into four tiles. FIG. 20 is a diagram schematically showing an example of the division and encoding of the foreground and the mask. As may be seen from this particular example shown in FIG. 20, the division boundaries are set in order to enable the partial access, but the size of the divided region or the number of divisions does not need to be the same for the foreground and the mask. This other embodiment applied to the tile division may be applied similarly to the precinct division, and also to the case where the divided regions of the mask are treated as independent images and encoded as in the third and fourth embodiments described above. The process of this other embodiment of the present invention in general is similar to that of the flow chart shown in FIG. 12 for the first embodiment or FIG. 17 for the third embodiment, and illustration and description thereof will be omitted.

In the first through fourth embodiments of the present invention described above, the mask covers the entire page. However, as may be readily understood when the role of the mask is considered, it is sufficient for the mask to exist only at the location where necessary to plot the character pixel, for example, and it is not essential for the mask to cover the entire page (or the entire MRC image). Hence, in still another embodiment of the present invention, the foreground is divided into four tiles and subjected to the JPEG2000 encoding as shown in the upper part of FIG. 21. However, the mask is divided into four images to cover the location where necessary to plot the character pixel, for each region corresponding to each tile region, as shown in the lower part of FIG. 21, and the divided images are independently subjected to the JBIG encoding. FIG. 21 is a diagram schematically showing an example of the division and encoding of the foreground and the mask. The process of this other embodiment of the present invention in general is similar to that of the flow chart shown in FIG. 17 for the third embodiment, and illustration and description thereof will be omitted.

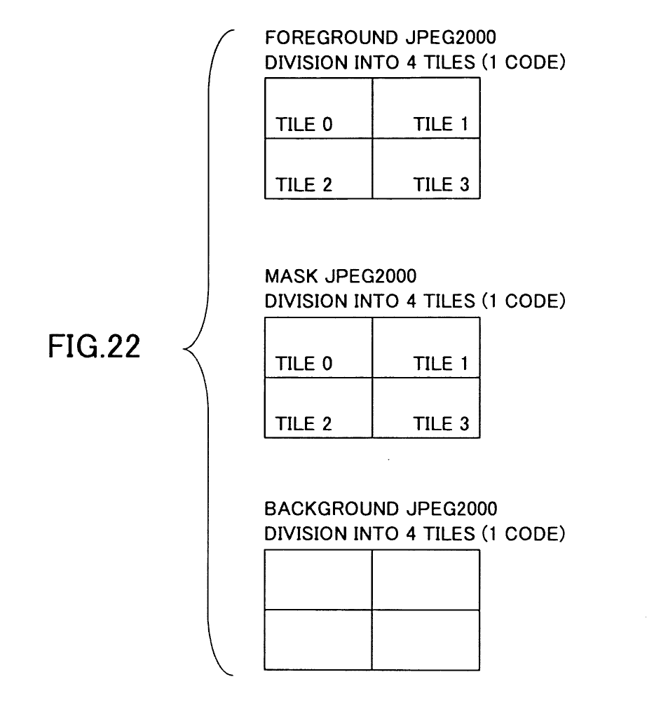

In the embodiments of the present invention described above, the background is a single color in accordance with the JPM. However, in the case where the background is not a single color, it is effective to also divide the background into divided regions and perform the encoding, so that the partial access is possible. For example, the original image data is decomposed into the foreground, the mask and the background as shown in FIG. I (that is, the background corresponding to the foreground 1 in FIG. 11, the mask corresponding to the mask 2 in FIG. 11, and the foreground corresponding to the foreground 2 in FIG. 11), and the foreground, the mask and the background are divided and encoded similarly to any of the embodiments described above. The results of dividing and encoding the foreground, the mask and the background become as shown schematically in FIGS. 22 through 25. FIGS. 22 through 25 are diagrams schematically showing examples of the division and encoding of the foreground, the mask and the background.

FIG. 22 schematically shows an example where the tile division using matching division boundaries is performed with respect to the foreground, the mask and the background, and the JPEG2000 encoding is performed.

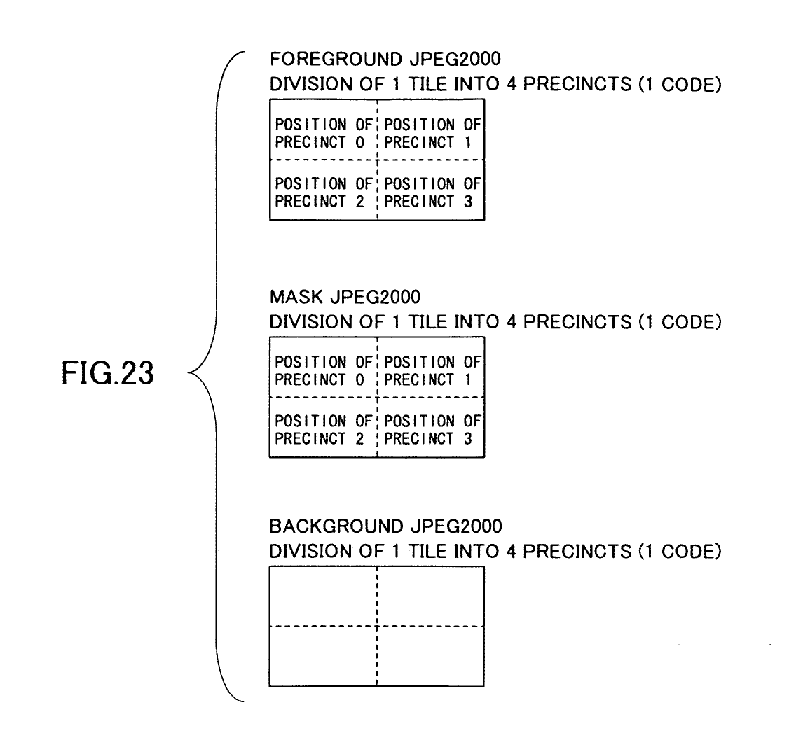

FIG. 23 schematically shows an example where the precinct division is performed with respect to the foreground, the mask and the background, and the JPEG2000encoding is performed.

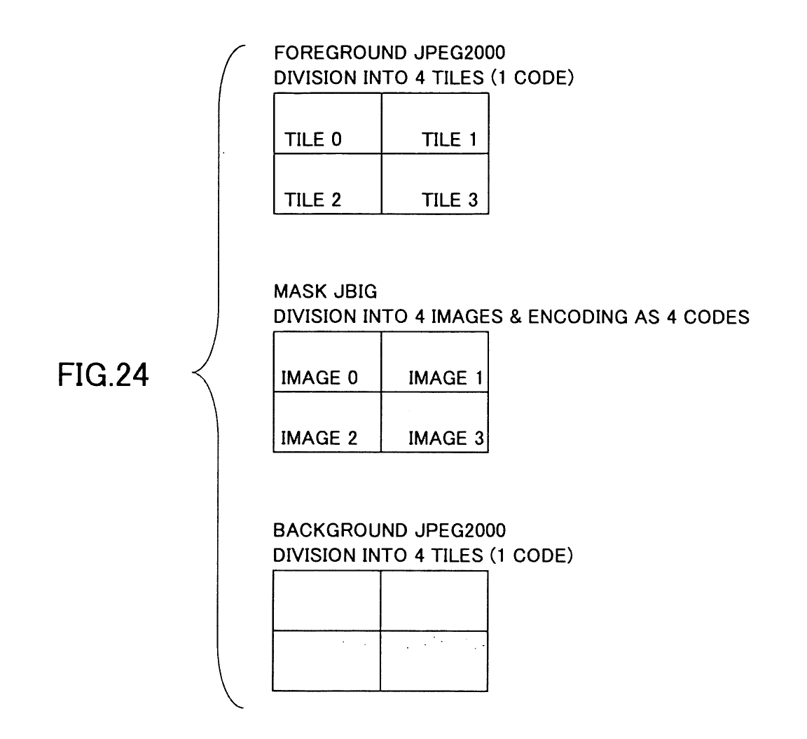

FIG. 24 schematically shows an example where the tile division is performed with respect to the foreground and the background, and the JPEG2000 encoding is performed, while the mask is divided into four region parts (images 0, 1, 2 and 3) matching the tile boundaries and the JBIG encoding is performed independently with respect to each of the region parts.

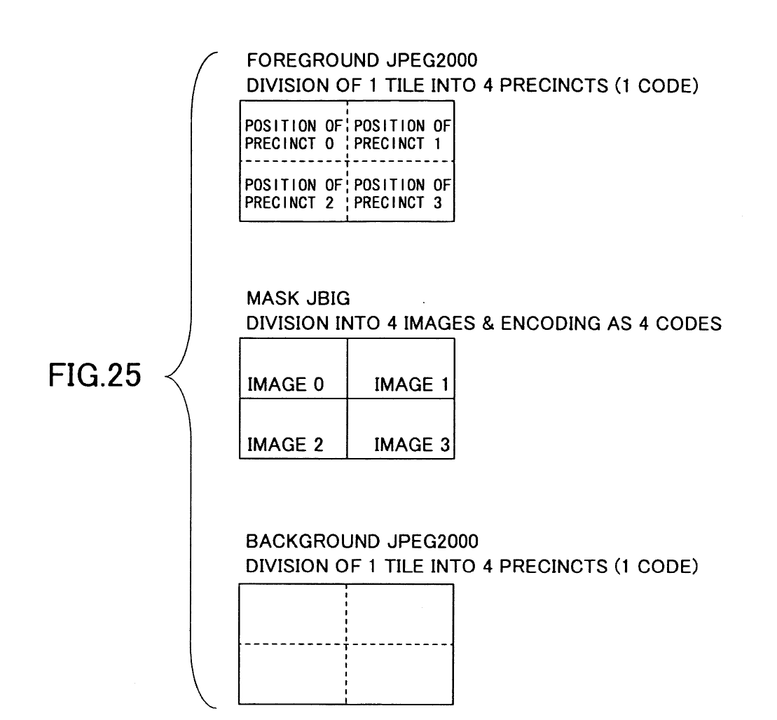

FIG. 25 schematically shows an example where the precinct division is performed with respect to the foreground and the background, and the JPEG2000 encoding is performed, while the mask is divided into region parts matching the precinct boundaries and the JBIG encoding is performed independently with respect to each of the region parts.

A detailed description of FIGS. 22 through 25 will be omitted because the associated processes are readily understandable from the process of the first through fourth embodiments described above.

This application claims the benefit of a Japanese Patent Application No. 2005-152340 filed May 25, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. An encoding method comprising:
acquiring background data, and at least one pair of foreground data and mask data, that are obtained by decomposing original image data; and
encoding the background data, the foreground data and the mask data, including performing a JPEG2000 encoding using tile division or precinct division with respect to the mask data.

2. The encoding method as claimed in claim 1, wherein encoding the background data, the foreground data and the mask data comprises performing the JPEG2000 encoding using the tile division or the precinct division with respect to the foreground data, and matches division boundaries of the foreground data and the mask data.

3. The encoding method as claimed in claim 1, wherein encoding the background data, the foreground data and the mask data comprises dividing the foreground data into a plurality of region parts, independently encoding each of the region parts, and matching division boundaries of the foreground data and the mask data.

4. The encoding method as claimed in claim 1, wherein encoding the background data, the foreground data and the mask data comprises performing the JPEG2000 encoding using the tile division or the precinct division with respect to the background data, and matching division boundaries of the background data and the mask data.

5. The encoding method as claimed in claim 1, wherein encoding the background data, the foreground data and the mask data comprises dividing the background data into a plurality of region parts, independently encoding each of the region parts, and matching division boundaries of the background data and the mask data.

6. The encoding method as claimed in claim 2, wherein encoding the background data, the foreground data and the mask data comprises performing the JPEG2000 encoding using the tile division or the precinct division with respect to the background data, and matching division boundaries of the background data and the mask data.

7. The encoding method as claimed in claim 3, wherein encoding the background data, the foreground data and the mask data comprises performing the JPEG2000 encoding using the tile division or the precinct division with respect to the background data, and matching division boundaries of the background data and the mask data.

8. The encoding method as claimed in claim 2, wherein encoding the background data, the foreground data and the mask data comprises dividing the background data into a plurality of region parts, independently encoding each of the region parts, and matching division boundaries of the background data and the mask data.

9. The encoding method as claimed in claim 3, wherein encoding the background data, the foreground data and the mask data comprises dividing the background data into a plurality of region parts, independently encoding each of the region parts, and matching division boundaries of the background data and the mask data.

10. An encoding method comprising:
acquiring background data, and at least one pair of foreground data and mask data, that are obtained by decomposing original image data; and
encoding the background data, the foreground data and the mask data, including dividing the mask data into a plurality of region parts, and independently encoding each of the region parts.

11. The encoding method as claimed in claim 10, wherein encoding the background data, the foreground data and the mask data comprises performing the JPEG2000 encoding using the tile division or the precinct division with respect to the foreground data, and matches division boundaries of the foreground data and the mask data.

12. The encoding method as claimed in claim 10, wherein encoding the background data, the foreground data and the mask data comprises dividing the foreground data into a plurality of region parts, independently encoding each of the region parts, and matching division boundaries of the foreground data and the mask data.

13. The encoding method as claimed in claim 10, wherein encoding the background data, the foreground data and the mask data comprises performing the JPEG2000 encoding using the tile division or the precinct division with respect to the background data, and matching division boundaries of the background data and the mask data.

14. The encoding method as claimed in claim 10, wherein encoding the background data, the foreground data and the mask data comprises dividing the background data into a plurality of region parts, independently encoding each of the region parts, and matching division boundaries of the background data and the mask data.

15. The encoding method as claimed in claim 11, wherein encoding the background data, the foreground data and the mask data comprises performing the JPEG2000 encoding using the tile division or the precinct division with respect to the background data, and matching division boundaries of the background data and the mask data.

16. The encoding method as claimed in claim 12, wherein encoding the background data, the foreground data and the mask data comprises performing the JPEG2000 encoding using the tile division or the precinct division with respect to the background data, and matching division boundaries of the background data and the mask data.

17. The encoding method as claimed in claim 11, wherein encoding the background data, the foreground data and the mask data comprising dividing the background data into a plurality of region parts, independently encoding each of the region parts, and matching division boundaries of the background data and the mask data.

18. The encoding method as claimed in claim 12, wherein encoding the background data, the foreground data and the mask data comprises dividing the background data into a plurality of region parts, independently encoding each of the region parts, and matching division boundaries of the background data and the mask data.

19. An encoding apparatus comprising:
a data acquiring unit to acquire background data, and at least one pair of foreground data and mask data, that are obtained by decomposing original image data; and
an encoding unit to encode the background data, the foreground data and the mask data acquired by the data acquiring unit,
wherein the encoding unit performs a JPEG2000 encoding using tile division or precinct division with respect to the mask data.

20. The encoding apparatus as claimed in claim 19, wherein the encoding unit does not apply a wavelet transform when encoding the mask data if an absolute value of each pixel position of the mask data is 0 or 2ⁿ, where n is an integer.

21. The encoding apparatus as claimed in claim 19, wherein the encoding unit performs the JPEG2000 encoding using the tile division or the precinct division with respect to the foreground data, and matches division boundaries of the foreground data and the mask data.

22. The encoding apparatus as claimed in claim 19, wherein the encoding unit divides the foreground data into a plurality of region parts, independently encodes each of the region parts, and matches division boundaries of the foreground data and the mask data.

23. The encoding apparatus as claimed in claim 19, wherein the encoding unit performs the JPEG2000 encoding using the tile division or the precinct division with respect to the background data, and matches division boundaries of the background data and the mask data.

24. The encoding apparatus as claimed in claim 19, wherein the encoding unit divides the background data into a plurality of region parts, independently encodes each of the region parts, and matches division boundaries of the background data and the mask data.

25. The encoding apparatus as claimed in claim 21, wherein the encoding unit performs the JPEG2000 encoding using the tile division or the precinct division with respect to the background data, and matches division boundaries of the background data and the mask data.

26. The encoding apparatus as claimed in claim 22, wherein the encoding unit performs the JPEG2000 encoding using the tile division or the precinct division with respect to the background data, and matches division boundaries of the background data and the mask data.

27. The encoding apparatus as claimed in claim 21, wherein the encoding unit divides the background data into a plurality of region parts, independently encodes each of the region parts, and matches division boundaries of the background data and the mask data.

28. The encoding apparatus as claimed in claim 22, wherein the encoding unit divides the background data into a plurality of region parts, independently encodes each of the region parts, and matches division boundaries of the background data and the mask data.

29. An encoding apparatus comprising:
a data acquiring unit to acquire background data, and at least one pair of foreground data and mask data, that are obtained by decomposing original image data; and
an encoding unit to encode the background data, the foreground data and the mask data acquired by the data acquiring part,
wherein the encoding unit divides the mask data into a plurality of region parts, and independently encodes each of the region parts.

30. The encoding apparatus as claimed in claim 29, wherein the encoding unit performs the JPEG2000 encoding using the tile division or the precinct division with respect to the foreground data, and matches division boundaries of the foreground data and the mask data.

31. The encoding apparatus as claimed in claim 29, wherein the encoding unit divides the foreground data into a plurality of region parts, independently encodes each of the region parts, and matches division boundaries of the foreground data and the mask data.

32. The encoding apparatus as claimed in claim 29, wherein the encoding unit performs the JPEG2000 encoding using the tile division or the precinct division with respect to the background data, and matches division boundaries of the background data and the mask data.

33. The encoding apparatus as claimed in claim 29, wherein the encoding unit divides the background data into a plurality of region parts, independently encodes each of the region parts, and matches division boundaries of the background data and the mask data.

34. The encoding apparatus as claimed in claim 30, wherein the encoding unit performs the JPEG2000 encoding using the tile division or the precinct division with respect to the background data, and matches division boundaries of the background data and the mask data.

35. The encoding apparatus as claimed in claim 31, wherein the encoding unit performs the JPEG2000 encoding using the tile division or the precinct division with respect to the background data, and matches division boundaries of the background data and the mask data.

36. The encoding apparatus as claimed in claim 30, wherein the encoding unit divides the background data into a plurality of region parts, independently encodes each of the region parts, and matches division boundaries of the background data and the mask data.

37. The encoding apparatus as claimed in claim 31, wherein the encoding unit divides the background data into a plurality of region parts, independently encodes each of the region parts, and matches division boundaries of the background data and the mask data.

38. An encoding apparatus comprising:
a data acquiring unit to acquire background data, and at least one pair of foreground data and mask data, that are obtained by decomposing original image data;
an encoding unit to encode the background data, the foreground data and the mask data acquired by the data acquiring unit; and
a code formation unit to form encoded data having a predetermined format by combining the background data, the foreground data and the mask data encoded by the encoding unit,
wherein the encoding unit divides the mask data into a plurality of region parts, and independently encodes each of the region parts, and
the code formation unit causes sharing of codes of the foreground data with codes of the plurality of region parts of the mask data.
